(19) United States
(12) Patent Application Publication
(10) Pub. No.: US 2009/0122359 A1
(43) Pub. Date: May 14, 2009

(54) Glass Member, Reading Apparatus and Image Formng Apparatus

(75) Inventors: Yoshikazu Kondo, Tokyo (JP); Atsushi Saito, Tokyo (JP); Hiromoto Ii, Tokyo (JP); Takahide Toyama, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KONICA MINOLTA HOLDINGS, INC., Tokyo (JP)

(21) Appl. No.: 11/795,483

(22) PCT Filed: Jan. 30, 2006
(86) PCT No.: PCT/JP06/01405

§ 371 Date: Jul. 18, 2007

(30) Foreign Application Priority Data
Feb. 1, 2005 (JP) 2005-024927

(51) Int. Cl. H04N 1/04

(52) U.S. Cl. 358/474

(57) ABSTRACT

An object of the invention is to provide an reading glass, an reading apparatus comprising the reading glass and an image forming apparatus comprising the reading apparatus, the reading glass which reduces attenuation of a light, which is of a light source or reflected by a document, passing through the reading glass, reduces attachment of paper powder and the like, and thus can provide high quality images. The present invention is characterized in that a glass member positioned between the document and the light source of the reading apparatus for optically reading the document has an antireflection function.

### TECHNICAL FIELD

The present invention relates to a glass member, a reading apparatus including the glass member, and an image forming apparatus including the reading apparatus.

### BACKGROUND ART

In recent years, glass members that have both high surface smoothness and antistatic properties are being employed in various areas. An example is the glass member (also called reading glass hereinafter), in the automatic document feeding copier, on which a document is set, and in order to prevent paper jams and attachment of dirt such as paper powder due to static electricity occurred at the time of paper feeding, the surface of the glass member is coated with a transparent conductive film such as an ITO film (a tin doped indium oxide film) or a tin oxide film to prevent generation of static electricity.

In the prior art of the reading glass including the conductive film, for example, at least the inside surface of the reading glass is coated with a transparent conductive film to prevent static (for example see Patent Document 1).

In one example, the glass member is coated with the tin oxide film and the Ra of the surface is 3 nm or less (for example see Patent Document 2).

In another example, the entire surface of the reading glass is coated with a conductive film, and a portion of high friction and a portion of low friction with respect to the document are formed on the conductive film (for example see Patent Document 3). Up until now, black and white image forming apparatus using this type of reading glass was often used for copying documents, and the demand for faithfully reproducing halftone was low.

For this reason, even if a small foreign material attaches to the reading glass for example, there are few opportunities for abnormalities to occur in the pattern of the output image, and this rarely became a big problem.

Patent Document 1: Unexamined Japanese Patent Application Publication No. H8-76276

Patent Document 2: Unexamined Japanese Patent Application Publication No. H9-208264

Patent Document 3: Unexamined Japanese Patent Application Publication No. H8-6177

### DISCLOSURE OF THE INVENTION

### Object of Invention

There have been increased opportunities to process color pictures in color image forming apparatuses of recent years and there is a great demand to faithfully reproduce halftone as a plane, and furthermore, there is high demand for the image quality equivalent to that of the photograph.

In the case where this type of halftone is formed as the plane, even when extremely small foreign particles attach to the document image reading glass (particularly the slit glass used when the document is moved and read), this appears as a streak defect in the pattern on the output image, and even a small streak defect becomes a critical defect in view of the desire for image quality equivalent to that of the photograph.

In addition, in the case where only glass is used, the reading glass has a large reflectance of 4-5%, and the light from light source or the reflected light from the document is reflected at the reading glass surface, and in the case where an antistatic layer is provided, the reflectance increases further to about 6%. As a result, the amount of image reflected light from the document image is small and this results in a reduction in the contrast difference. There is also variation at the time of A/D conversion for example, and this leads to reduction in image quality (noise). This is problematic in that it becomes impossible to meet the aforementioned need for image quality equivalent to that of the photograph.

As a result, transmittance of light differs depending on whether the conductive film which forms the antistatic film is present, or whether the low friction film is present, there is great image deterioration particularly in recent high image quality copiers with “higher image quality” in which halftone can be faithfully reproduced.

In addition, the foregoing antistatic layers all are high refraction films with a refraction index of 1.8 or more, and when they are mounted as a single film on a substrate of glass or the like, this causes an increase in reflectance. As a result, there is a reduction in transmittance, and light from the scanner light source to the document and the received light by the CCD for reading the reflected light by the cause a reduction in the amount. As a result, there are problems in that there is great image deterioration particularly in recent high image quality copiers with “higher image quality” in which halftone can be faithfully reproduced.

In view of the foregoing problems, an object of the invention is to provide a glass member capable of reducing attenuation of the light from light source or the reflected light from the document when it passes through the reading glass and also capable of reducing adhesion of paper powder and the like to supply a high quality images, and a reading apparatus including the glass member; and an image forming apparatus including the glass member.

### Means for Solving the Problems

The aforementioned objects of the invention are achieved by the inventions described in the following.

(1) A glass member positioned between a light source for a reading apparatus for optically reading documents and a document, wherein at least one surface of the glass member includes an antireflection function.

(2) The glass member according to (1), characterized in that the antireflection function is obtained from an antireflection layer formed on the glass substrate.

(3) The glass member according to (2), characterized in that the antireflection layer comprises a first layer and a second layer formed in order from the surface of the glass substrate, and the second layer has a lower refraction index than the first layer.

(4) The glass member according to any one of (1)-(3), characterized in that both surfaces of the glass member have antireflection function.

(5) The glass member according to (3) or (4), characterized in that a wavelength at which a reflectance of the glass member is minimum changes in accordance with a thickness of the second layer, and the second layer has a thickness at which the reflectance of the glass member is minimum at a wavelength corresponding to a wavelength at which an emission of the light source is maximum.

(6) The glass member according to any one of (3)-(5), characterized in that the glass substrate is a transparent glass, the second layer is a thin film including silicone oxide, and the first layer includes one of ITO, tin oxide and zinc oxide.

(7) The glass member according to any one of (3)-(6), characterized in that at least one of the first layer and the second layer is formed by atmospheric pressure plasma CVD.

(8) A reading apparatus comprising the glass member of any one of (1)-(7).

(9) An image forming apparatus comprising the reading apparatus of (8).

### EFFECTS OF THE INVENTION

(1) By providing the antireflection function on at least one side of the glass member, attenuation of the light from light source and the reflected light is reduced, and it becomes possible to provide a glass member in which light loss is a little.

(2) By forming the antireflection layer having an antireflection function on the glass substrate, attenuation of the light from light source and the reflected light is reduced, and it becomes possible to provide a glass member in which light loss is a little.

(3) By forming a first layer and a second layer which has a lower refraction index than the first layer successively on the glass substrate, attenuation of the light from light source and reflected light is reduced, and it becomes possible to provide a glass member in which light loss is a little.

(4) Because both surfaces of the glass member have an antireflection function, attenuation of the light from light light and reflected light is reduced at both surface, and it becomes possible to provide a glass member in which light loss is a little.

(5) Because the second layer has a thickness at which the reflectance of the reading glass is minimum at a wavelength corresponding to the wavelength of the maximum light amount of the light source, attenuation of the light from light source and reflected light is reduced in accordance with the type of light source and it becomes possible to provide a glass member in which light loss is a little.

(6) Because the second layer is a thin film including silicone oxide, and the first layer includes one of ITO, tin oxide and zinc oxide, static charging is difficult to occur, and attenuation of the light from light source and reflected light is reduced and it becomes possible to provide a glass member in which light loss is a little.

(7) Because at least one of the first layer and the second layer is formed of atmospheric pressure plasma CVD, low temperature continuous molding can be performed at 200° C. or less, damage such as warping of the glass of the substrate does not occur, and because film formation can be done with high productivity, it becomes possible to provide a high quality glass member at low cost.

(8) Because the reading apparatus includes the glass member of any one of (1)-(7), it becomes possible to provide a reading apparatus in which occurrence of abnormalities such as paper jams and the like due to static electricity suctioning during conveying the document is reduced; there is no attenuation in the amount of reflected light from the light source, and thus light loss is a little; it is possible to output high quality image information in which there is no reduction in image quality due to paper powder; and maintenance is easy.

(9) Because the image forming apparatus includes the reading apparatus of (8), based on the foregoing effects, it becomes possible to provide an image forming apparatus capable of outputting high quality images and capable of easy maintenance.

### BRIEF DESCRIPTION OF THE DRAWINGS

FIG. 1 is a schematic sectional view for describing the reading glass.

FIG. 2 is a schematic explanatory diagram of one example of the manufacturing device for the reading glass comprising at least the antistatic film and the antireflection film of the invention.

FIG. 3 is a schematic structural diagram for showing one example of the antistatic film formation section for forming the antistatic film used in the invention.

FIG. 4 is a schematic structural diagram for showing one example of the antireflection film formation section for forming the antireflection film used in the invention.

FIG. 5 shows a reading apparatus including the reading glass according to an embodiment of the invention and an image forming apparatus comprising the reading apparatus.

FIG. 6 is an explanatory view showing light from the light source hitting the document and the reflected light from the document being reflected.

FIG. 7 is an explanatory diagram for describing reduction of reflection at the reading glass due to the antistatic film and the antireflection film.

FIG. 8 is an explanatory diagram showing changes in reflection at the reading glass according to the thickness of the antireflection layer.

### DESCRIPTION OF THE NUMERALS

4 Antistatic film formation section
5 Antireflection film formation section
6 Low friction layer formation section
7 Document
11 Glass substrate
12 Antistatic film
13 Antireflection film
14 Low friction layer
41, 51, 61 Fixed electrode
42 Moving base electrode
43 First high frequency power source
44, 64 Discharge gas supply section
45, 65 Thin film gas supply section
47, 57, 67 Slit
48, 68 Excited gas
53 Second high frequency power source
54 Oxidizing gas supply section
58 Excited oxidizing gas
63 Third high frequency power source
73 Fourth high frequency power source
80 Reading light source
82 Reflected light 82 from document 7
83 Transmitted light
84 Document image reading section
100 Reading glass
101 Slit glass
102 Platen glass
A, B Discharge space
G1, G4 Discharge gas
G2, G5 Thin film forming gas
G3 Oxidizing gas

### BEST MODE FOR CARRYING OUT THE INVENTION

The glass member described in this specification is a transparent member generally called reading glass and is positioned between an optical system and a light source of a document image reading apparatus for reading documents and document image information when the document image information is being read, and it prevents paper powder and the like from the document from entering the light source and the optical system; prevents the operator from giving damage to the light source and the optical system; and positions the document on the focus point position of the optical system of the reading apparatus.

The glass member is called reading glass in the following.

The inventors of the invention conceived of the invention when they discovered the following facts. In the reading glass for reading apparatuses such as scanners, fax machines, copiers and the like and for reading apparatuses for image forming apparatuses, to accommodate the problems that the amount of the reflection of the light from light source and the reflected light by the document tends to increase, attachment of paper powder and document conveyance defects tend to occur; by forming on the glass surface, a first layer including one of ITO, tin oxide and zinc oxide, and second layer which is an antireflection layer and includes silicon oxide whose refraction index is lower than that of the first layer, at least one of the first layer and the second layer being formed by atmospheric pressure plasma CVD, for achieving an antireflection function for reducing attenuation of document image light and the like due to an increase in reflectance, an antistatic function for reducing suction of a transfer sheet onto the glass surface due to the static electricity, a conveyance resistance reducing function for the glass surface, and more preferably a soiling prevention function for reducing the attachment of finger prints and the like; attenuation of the light from light light and reflected light is reduced, attachment of paper powder is reduced, and adhesion to the reading glass for the document is reduced, and also by including a low friction layer including fluorine in the uppermost layer, document conveyance resistance is reduced and attachment of finger prints and the like is reduced.

It is to be noted that the pressure at atmospheric pressure or a vicinity of atmospheric pressure is 20 kPa-200 kPa and more preferably 70 kPa-140 kPa.

First the reading glass will be described.

FIG. 1 is a schematic sectional view for describing the reading glass.

The following description will use a reading glass which has 2 layers on one side of the transparent substrate and generates antireflection function.

It is to be noted that in the reading glass, the film and the like described hereinafter which generate the antireflection function may be on both surfaces or one surface (front surface or back surface), but it is preferably on the back surface which is the opposite surface to the document loading surface.

The reading glass 100 comprises a glass member positioned between a light source for the reading apparatus for optically reading documents and a document, wherein the glass member has antireflection function, or in other words at least one surface of the glass member 11 includes a first layer 12 formed on the front surface of the glass member 11; and a second layer 13 which is formed on the first layer 12 and has a lower refraction index than the first layer 12, and the first layer and the second layer form the antireflection layer 10.

(The antireflection function is exhibited by the combination of first layer and the second layer formed on the first layer, and the second layer by itself does not have antireflection function. That is to say, the reflection light from the glass surface and the reflected light reflected at the boundary of the first layer and the second layer cause acts as interference and the antireflection function is exhibited by the reflected light from the glass surface being counteracted, but to make the explanation simple, in the following the first layer 12 will be called the antistatic film 12 and the second layer 13 will be called the antireflection layer 13 for the sake of convenience.)

The antireflection film 13 includes silicone oxide and the antistatic film 12 includes any one of ITO, tin oxide and zinc oxide.

Furthermore, a low friction layer 14 including fluorine as the uppermost layer may be formed.

Examples of the glass used in the glass substrate 11 include soda-lime glass, boron silicate glass, super purified glass and crystal glass. In addition, chemically reinforced glass in which sodium on the surface of the soda glass is replaced mostly by potassium, and stiffness is improved may be used.

It is to be noted that glass substrate 11 which is the substrate for the reading glass is glass which transparent and has a prescribed strength, but it may not be glass as long as it satisfies the foregoing conditions, and synthetic resins such as plastics and the like may be used.

In addition, the case in which the antistatic film 12, the antireflection film 13, and the low friction film 14 are formed on one side of the glass substrate 11 has been described, but a number of combined films of antistatic film 12 and antireflection film 13 may be formed between the glass substrate 11 and the low friction film 14, and the antireflection function is thereby improved.

In view of simplicity, the case described in the following is that the antistatic film 12, the antireflection film 13, and the low friction film 14 are formed on one side of the glass substrate 11.

First, the formation of the antistatic film 12 and the antireflection film 13 will be described.

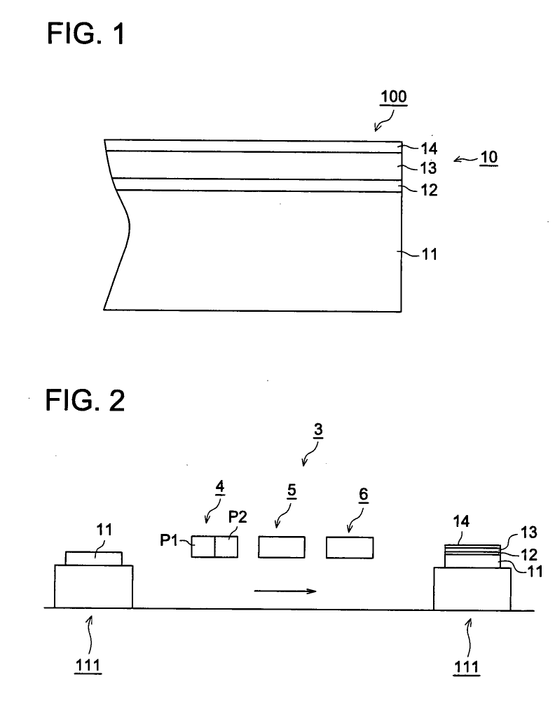

FIG. 2 is a schematic explanatory diagram of one example of the manufacturing device for the reading glass comprising at least the antistatic film and the antireflection film of the invention.

The manufacturing device 3 for the reading glass comprises a glass substrate conveyance section 111; an antistatic film formation section 4; an antireflection film formation section 5; and a low friction film formation section 6, and the glass substrate 11 is successively conveyed by the glass substrate conveyance section 111 which mounts the glass substrate 11 and then conveys it in the following order in the direction of the arrow to the following sections of the antistatic film formation section 4 which comprises at least two processes for forming the antistatic film 12; the antireflection film formation section 5 which forms the antireflection film 13; and a low friction film formation section 6 which forms the low friction film 14; and a prescribed film is formed at these sections using atmospheric pressure plasma processing.

Next the formation of antistatic film that has a higher refraction index than the antistatic film will be described.

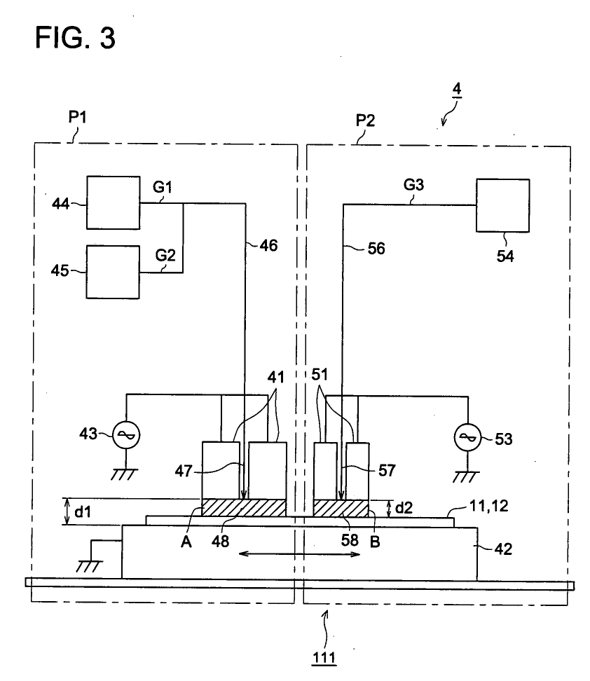

FIG. 3 is a schematic structural diagram for showing one example of the antistatic film formation section for forming the antistatic film used in the invention.

The antistatic film 12 formed on the glass substrate 11 comprises one of ITO, tin oxide and zinc oxide, and the antistatic film 12 is formed by atmospheric pressure plasma CVD processing in which gas is excited under a pressure of atmospheric pressure or a vicinity of atmospheric pressure, and then the surface that was subjected to atmospheric pressure plasma processing is subjected to oxidation processing and thereby formed by at least two processes.

In this manner, the formation of the antistatic film 12 is done at the antistatic film formation section 4 which comprises a first process (simply called P1 hereinafter) and a second process (simply called P2) hereinafter.

The interval between P1 and P2 is preferably as short as possible, and it is particularly preferable that processes of P1 and P2 are installed in the same space to be adjacent.

Next, the formation of the antistatic film will be described in detail.

In the first process P1, (the region enclosed by the dotted chain line in the drawing), opposing electrodes are formed by the fixed electrode 41 and the moving base electrode 42 of the glass substrate conveyance section 111, and a high frequency field is applied between the electrodes by the high frequency power source 43, and the discharge gas G1 is supplied from the discharge gas supply section 44 and the thin film formation gas G2 is supplied from the thin film formation gas supply section 45 via the thin film formation gas supply pipe 46, and the gasses pass through the slit 47 formed in the fixed electrode 41 and flow out to the discharge space A.

The discharge gas G1 and the thin film formation gas G2 are excited by the applied high frequency field to form excited gas 48.

The discharge space herein refers to the space enclosed by the electrodes arranged opposite to each other and be separated by a prescribed distance, and by introducing discharge gas and the like between the electrodes and applying an electric field to the gas, discharge is caused.

In addition, a thin film is formed on the surface of the glass substrate 11 which is mounted on the moving base electrode 42 by being exposed to the excited gas.

The discharge gas used in the first process P1 is preferably a rare gas such as helium, argon or the like.

The thin film formation gas G2 is one which itself can be excited and become active and is chemically deposited on the substrate to form a thin film, and the preferable metal of an organic metal compound for forming the layer is at least one selected from indium (In), zinc (Zn), and tin (Sn).

Examples of the obtained transparent conductive film which is the antistatic film include oxide film of SnO₂, In₂O₃, and ZnO or complex oxides formed by doping dopant such as a Sb doped SnO₂, F doped SnO₂ (FTO), Al doped Zno, Sn doped In₂O₃ (ITO) and the like, and an amorphous film having at least one selected from this group as a main component is preferable.

In this invention, examples of preferable organic metal compounds include indium tris(2,4 pentanedionate), indium tris(hexafluoropentane dionate), indium triaceto acetate, triacetoxy indium, dietoxyacetoxy indium, triisopropoxyindium, dietoxy indium(1,1,1-trifluoropentane dionate), tris(2,2,6,6-tetramethyl-3,5 heptane dionate)indium, etoxy indium bis(acetomethyl acetate), di(n)butyl tin bis(2,4-pentane dionate), di(n)butyl diacetoxy tin, di(t)butyl diacetoxy tin, tetra isopropoxy tin, tetra(i)butoxy tin, and bis(2,4-pentane dionate)lead. These organic metal compounds are generally commercially available (from Tokyo Chemical Industries for example).

<Doping>

In this invention, in addition to the organic metal compounds having at least one oxygen atom in the molecule mentioned above, in order to further increase the conductivity of the transparent conductive film formed from the organic metal compound, it is preferable that the transparent conductive film is doped, and it is also preferable that the organic metal compound as the thin film formation gas and the organic metal compound gas for doping are simultaneously mixed and used. Examples of the organic metal compound used for doping or the film formation gas which is a fluorine compound include: triisopropoxy aluminum, tris(2,4-pentanedionate)nickel, bis(2,4-pentanedionate)manganese, isopropoxy boron, tri(n)butoxy antimony, tri(n)butyl antimony, di(n)butyl bis(2,4-pentanedionate)tin, di(n)butyl diacetoxy tin, di(t)butyl diacetoxy tin, tetraisopropoxy tin, tetrabutoxy tin, tetrabutyl tin, zinc di(2,4-pentanedionate), hexafluoro propylene, octafluoro cyclobutane, and quadifluoro methane and the like.

The proportion of the organic metal compound required for forming the transparent conductive film and the foregoing thin film formation gas for doping is different depending on the type of transparent conductive film to be formed, but the ITO film obtained by doping indium oxide with tin, the amount of thin film formation gas must be adjusted such that the proportion of the number of atoms for the In and Sn proportion is in the range of 100:0.1-100:15. It is preferably adjusted to be in the range 100:0.5-100:10. In the transparent thin film obtained by doping tin oxide with fluorine (called FTO film), the proportion of thin film formation gas is preferably adjusted such that the proportion of the number of atoms for the Sn and F proportion in the obtained FTO film is in the range of 100:0.01-100:50. In the In₂O₃—ZnO based amorphous transparent conductive thin film, the proportion of thin film formation gas is preferably adjusted such that the proportion of the number of atoms for the In and Zn proportion is in the range of 100:50-100:5. The ratios of the number of atoms which are the In:Sn ratio, the Sn:F ratio and the In:Zn ratio can be obtained by XPS measurement.

In this invention, the amount of the transparent conductive film forming gas is preferably 0.01-10% by volume with respect to the mixed gases.

Next, the glass substrate 11 moves to the second process P2 (area enclosed by the dotted chain line in the Fig.) along with the moving base electrode 42. In the second process P2, opposing electrodes are formed by the fixed electrode 51 and the moving base electrode 42, and high frequency voltage is applied between the electrodes by the second high frequency power source 53 and the oxidizing gas G3 is supplied from the oxidizing gas supply section 54 via the oxidizing gas supply pipe 56, and the gas passes through the slit 57 formed in the fixed electrode 51 and flows out to the discharge space B.

The oxidizing gas G3 that flows out to the discharge space B is excited by the applied high frequency field to form excited oxidizing gas 58.

In addition, the surface of the glass substrate 11 which is mounted on the moving base electrode 42 is subjected to oxidation processing by being exposed to the excited oxidizing gas 58.

Examples of the oxidizing gas include oxygen, ozone, hydrogen peroxide, carbon monoxide, and nitrogen dioxide, but oxygen, ozone and carbon monoxide are preferable, and it is also preferable that the component selected from this group is mixed with the discharge gas. The amount of the discharge gas included is preferably 0.0001-30% by volume of the total amount of gas, and more preferably 0.001-15% by volume, and 0.01-10% by volume is particularly preferable.

An antistatic film having a prescribed thickness can be formed by going back and forth between the thin film formation of the first process P1 and the oxidation processing of the second process P2.

The first high frequency power source 43 herein may also be one which superposes and applies different high frequency voltages of at least 2 wavelengths. In this case, a favorable plasma discharge can be formed using a gas such as nitrogen gas for which the start voltage for discharge is high, and which is low in cost.

The fixed electrodes 41, 51 and the moving base electrode 42 respectively are formed by spraying ceramic, which is a dielectric, onto a conductive base metal, and then performing sealing using a sealing material which is an inorganic compound. The ceramic dielectric may have coating thickness of about 1 mm on one side.

The ceramic material used for spraying is preferably alumina or silicon nitride, but alumina is particularly preferable as processing is easy. In addition, the dielectric layer may use a lining-processed dielectric in which an inorganic material is provided by a glass lining.

Examples of the conductive base metal include metals such as titanium metal or titanium alloys, silver, platinum, stainless steel, aluminum, and iron; complexes such as complexes of iron and ceramics, complexes of aluminum and ceramics, but titanium metal or titanium alloys are particularly preferable.

The space d1 between the opposing electrodes is set in consideration of the thickness of the dielectric provided on the conductive base metal and the size of the applied voltage, but the minimum distance between the dielectric surface and the conductive base metal surface in case of only one electrode being provided with dielectric and the minimum distance between two dielectrics in case of both electrodes being provided with dielectric are preferably 0.1-20 mm, and particularly preferable is 0.5-6 mm in view of carrying out even charging. In addition, by placing the substrate between the opposing electrodes, the space will vary in accordance with the thickness of the substrate, but the space d2 between the voltage applied electrode and substrate is preferably in the range from 0.5-3 mm.

Next, the first high frequency power source 43 and the second high frequency power source 53 will be described. In the first high frequency power source 43, the higher the frequency is, the higher plasma density is, and a dense good quality film can be obtained, accordingly, the frequency is preferably between 800 kHz and 200 MHz.

Examples of this type of power source include the following commercially available products from which a selection can be suitably made.

| Maker | Frequency | | Product Name |
|---|---|---|---|
| Pearl Kogyo Co., Ltd. | 800 | kHz | CF-2000-800k |
| Pearl Kogyo Co., Ltd. | 2 | MHz | CF-2000-2M |
| Pearl Kogyo Co., Ltd. | 13.56 | MHz | CF-5000-13M |
| Pearl Kogyo Co., Ltd. | 27 | MHz | CF-2000-27M |
| Pearl Kogyo Co., Ltd. | 150 | MHz | CF-2000-150M |

It is to be noted that the power sources above marked with an asterisk are Haiden Laboratory impulse high frequency power sources (100 kHz in the continuous mode). The rest are high frequency power sources in which only continuous sine wave can be applied.

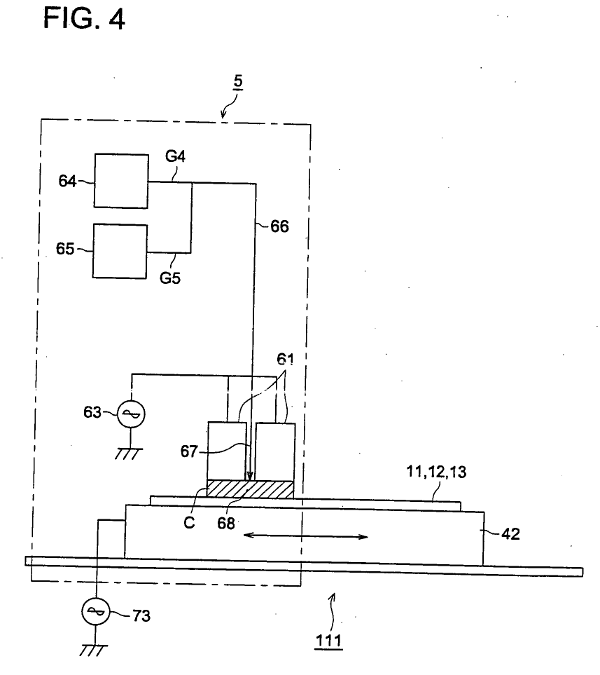

Next, the structure of the antireflection film 13 that has a lower refractive index than the antistatic film 12 will be described. FIG. 4 is a schematic structural diagram for showing one example of the antireflection film formation section for forming the antireflection film used in this invention.

The antireflection film formation section 5 is described with reference to FIG. 2, and in the post-process of the antistatic film formation section 4, the antireflection film 13 formed on the antistatic film 12 includes silicone oxide, and the layering is done by performing atmospheric pressure plasma CVD processing in which gas is excited at atmospheric pressure or a vicinity of atmospheric pressure using an electric field in which at least two different frequencies are superposed.

The following is a detailed description of the formation of the antireflection film.

The opposing electrodes are formed by the fixed electrode 61 of the antireflection film formation section 5 and the moving base electrode of the glass substrate conveying section 111, and a high frequency field is applied between the electrodes by the third high frequency power source 63 and the fourth high frequency power source 73 and the discharge gas G4 is supplied from the discharge gas supply section 64 and the thin film formation gas G5 is supplied from the thin film formation gas supply section 65 via the thin film formation gas supply pipe 66, and the gasses pass through the slit 67 formed in the fixed electrode 61 and flows out to the discharge space C.

The discharge gas G4 and the thin film formation gas G5 that flow out to the discharge space C are excited by a high frequency field obtained by superimposing the frequency ω1 of the third high frequency power source 63 with the different frequency ω2 of the fourth high frequency power source 73 to produce excited gas 68.

The surface of the glass substrate 11 which is mounted on the moving base electrode 42 is subjected to oxidation processing by being exposed to the excited gas 68.

The thickness of the antireflection film herein becomes thick if, for example, the exposing time in the discharge space B is long, and thus in order for it to have a prescribed thickness, the moving base electrode 42 is caused to move back and forth for prescribed times under the discharge space B.

The discharge gas G4 used may be oxygen, nitrogen, hydrogen, argon or the like and is preferably nitrogen in view of cost.

The thin film formation gas G5 is one which itself can be excited and become active and is a material which is chemically deposited on the substrate to form a thin film, and a silicon compound, a fluorine compound, or a mixture of silicon compound and a fluorine compound are preferably used as the thin film formation gas G5. These compounds may be used singly or in combination of 2 or more in order to adjust the refraction index to be lower than the refraction index of the antistatic film.

Examples of the silicon compounds used as the thin film formation gas for forming the antireflection film which has a lower refraction index than the antistatic film including one of the foregoing ITO, tin oxide and zinc oxide used in the present invention include organic silicon compounds, silicon-hydrogen compound and halogenated silicon compounds. Examples of the organic silicon compound include tetraethyl silane, tetramethyl silane, tetraisopropyl silane, tetrabutyl silane, tetraetoxy silane, tetra isoproxy silane, tetrabutoxy silane, dimethyldimethoxy silane, diethyldietoxy silane, diethyl silane di(2,4-pentane dionate), methyl trimetoxy silane, methyl trimetoxy silane, and ethyl trimetoxy silane and the like; and examples of the silicon-hydrogen compound include tetrahydrogen silane, hexahydrogen silane and the like; examples of the halogenated silicon compound include tetra chlorosilane, methyl trichlorosilane, diethyldichlorosilane and the like, and any of these may be favorably used in this invention. In addition the fluorine compounds may also be used. Two or more of these thin film formation gases may be mixed and used. Also, two or more of these compounds, tin compounds, titanium compounds, and silicon compounds may be suitably mixed and used for fine adjustment of the refractive index.

The organic tin compound, the organic titanium compound and the organic silicone compound are preferably metal-hydrogen compounds and alkoxy metals in view of handling, and the alkoxy metals are preferably used because there is little corrosion and generation of harmful gasses, and there is also little contamination in the process. In addition in order to introduce the organic tin compound, the organic titanium compound and the organic silicone compound in the space between the electrodes which is the discharge space, both may be solid, liquid or gas at room temperature and normal pressures. In the case where they are gas, the gas can be introduced into the electrode space as it is, but if they are liquid or solid, they must be made into gas by unshown means of heating, pressure reduction or ultrasonic wave radiation.

The fixed electrode 61 can be one of the same material and structure as that used in the antistatic film formation section 4.

The formation of the antireflection film formed by the atmospheric plasma CVD using the electric field having at least 2 different wavelengths is done by exposing the substrate to the gas excited in the discharge space which is between the fixed electrode 61 to which the high frequency power source of wavelength ω1 is connected and the moving base electrode 42 to which the fourth high frequency power source 73 of wavelength ω2 is connected.

Here, the frequency ω2 of the fourth high frequency power source 73 is higher than the frequency ω1 of the high frequency field of the high frequency power source 63, and the relationship between the strength V1 of the high frequency field of the high frequency power source 63, the strength V2 of the high frequency field of the fourth high frequency power source 73, and the strength IV of the discharge starting field satisfies V1≧IV>V2 or V1>IV≧V2, and the density of the high frequency field of the fourth high frequency power source 73 is preferably 1 W/cm² or more.

In the case where both the third high frequency power source 63 and the fourth high frequency power source 73 are sine waves, the high frequency field generated between the fixed electrode 61 and the moving base electrode 42 is a component in which the frequency ω1 and the frequency ω2 are superimposed, and the waveform thereof is one in which the sine wave of the frequency ω2 which is higher than that of frequency ω1 is superimposed on the sine wave of frequency ω1.

In this invention, the strength of the discharge starting field indicates the strength of the lowest field that can start discharge in the discharge space (electrode structure and the like) used in the actual thin film formation method and the reaction conditions (gas conditions). The strength of the discharge start field may vary to some extent depending on the type of gas supplied to the discharge space, the type of dielectric of the electrode and the space between the electrodes and the like, but in the same discharge space, it is controlled by the strength of the discharge starting field of the discharge gas.

By applying the type of high frequency field described above in the discharge space, it is estimated that discharge which makes film formation possible begins, and high density plasma required for thin film formation can be generated.

Superimposing of continuous sine wave was described above, but other configurations are possible, and both may be pulse waves, and one may be a continuous wave and one may be a pulse wave. In addition there may a third field.

The strength of the high frequency field (strength of the applied field) and the strength of the discharge starting field in this invention refers to that measured by the following method.

Method for measuring strength V1 and V2 (unit: kV/mm) of high frequency field:

A high frequency voltage probe (P6015A) is placed in each electrode section and the output signal from the high frequency voltage probe is connected to an oscilloscope (TDS3012B manufactured by Tektronix) and the strength of the field is measured.

Method for measuring strength IV (unit: kV/mm) of the discharge starting field:

Discharge gas is supplied between the electrodes, and the strength of the field between the electrodes is increased, and then the strength IV of the field up until when discharge begins is defined as the discharge starting strength IV. The measuring device is the same as that for measuring the strength of the high frequency electric field.

Due to this type of structure and discharge conditions, discharge is started even for gases which have a strong discharge starting field such as nitrogen gas, and a stable plasma state which has high density can be maintained and high speed film formation can be carried out.

In the case where the discharge gas in the measurement above is nitrogen gas, the strength of the discharge starting field IV is (1/2 Vp-p) is about 3.7 kV/mm and thus in the above relationship, by applying the strength of the first high frequency field at V1≧3.7 kV/mm, the nitrogen gas is excited into the plasma state.

The frequency ω1 of the third high frequency power source 63 is preferably 200 kHz or less. In addition, the field waveform may be a continuous wave or a pulse wave. The lower limit is preferably about 1 kHz.

On the other hand, the frequency ω2 of the fourth high frequency power source 73 is preferably 800 kHz or more. The higher the frequency of the second power source is, the higher the plasma density is, and a dense thin film of good quality is obtained.

Applying a high frequency field from these two power sources is necessary for starting discharge of the discharge gas having a higher discharge starting field strength than the high frequency field of the third high frequency power source 63. In addition, an important point in this invention is the fact that the plasma density is made high by the high frequency and the high output density of the high frequency field of the fourth high frequency power source 73, and a dense thin film of good quality can be formed.

In addition, by increasing the output density of the high frequency field of the third high frequency power source 63, the output density of the high frequency field of the fourth high frequency power source 73 can be improved while maintaining discharge uniformity as it is, and an even more uniform high density plasma can be produced, and an improvement of the manufacturing speed and the film quality can both be achieved.

The formation of the low friction film 14 may be done by forming the low friction film 14 including fluorine on the antireflection layer by using a film formation gas including a fluorine compound by the same plasma CVD processing under atmospheric pressure or a vicinity of atmospheric pressure as described above.

Another method for providing the reading glass with antireflection function is providing a plurality of layers on the glass substrate of the reading glass, and by providing extremely small convexo-concave portions having size/depth of a few dozen to a few hundred nm on the surface of the outermost layer, the light interference can be used to reduce reflection.

The atmospheric pressure plasma CVD processing device used in film formation of this invention is one in which a high frequency field is applied between opposing electrodes to cause discharge, and the discharge gas that has been introduced between the opposing electrodes, and the thin film formation gas are excited and transformed to the plasma state, and the substrate that is kept still or moved between the opposing electrodes is disposed to a plasma state gas, and a thin film is thereby formed on the substrate. However, as another system, a plasma jet system can be used, the system in which the atmosphere pressure plasma CVD processing device discharges between a pair of opposing electrodes and excites gas introduced between the opposing electrodes into plasma state and blow the gas in a plasma state to the outside of opposing electrodes (outside the discharge space), and the substrate in the vicinity of the opposing electrodes is disposed thereto to form a thin film on the substrate.

As described above, it is possible to supply a reading glass that has antistatic function by forming an antistatic film on a glass substrate using atmospheric pressure plasma CVD using electric fields of at least 2 different frequencies, using at least one type of organic metal compound selected from indium (In), zinc (Zn) and tin (Sn), and by superimposing on the antistatic layer an antireflection film which has a lower refraction index than the antistatic layer using atmospheric pressure plasma CVD using an electric fields of 1 frequency, using at least one type of organic silicon compound selected from an organic silicon compound, a silicon-hydrogen compound and a halogenated silicon compound.

It is to be noted that if the foregoing antistatic film and antireflection film are formed on both sides of the glass substrate, the reflected light is preferably reduced, the reflected light which is a loss of the light from light source and light reflected from the document.

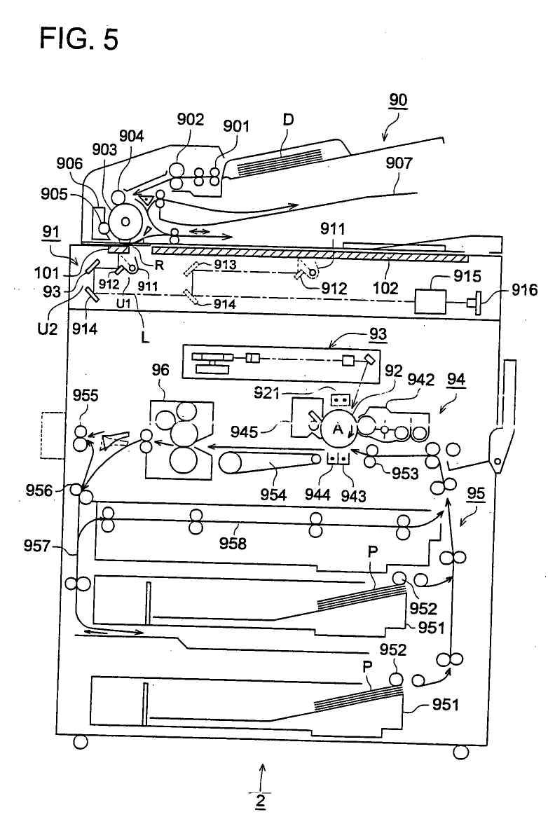

FIG. 5 shows a reading apparatus comprising reading glass according to an embodiment of this invention and an image forming apparatus comprising a reading apparatus.

The image forming apparatus 2 comprises: an automatic document feeding device 90 which takes one sheet of the document D at a time and conveys it; a document reading apparatus (called reading apparatus hereinafter) 91 of this invention; a scanning exposure section 93 for forming latent images on a photoreceptor drum 92 based on the document image information read by the reading apparatus 91; an image forming section 94 which makes the latent image visible using toner; a sheet feeding path 95 which is the sheet feeding path for the transfer sheet P; a fixing unit 96 which fixes the toner image using heat.

First, the reading of the document image will be described. Reading apparatus 91 which reads the document image comprises; a slit glass 101 which is the first embodiment of the reading glass 100 of this invention which was described with reference to FIGS. 1-4 and the platen glass 102 which is the second embodiment thereof, an optical unit U1 (also called scanning unit U1 hereinafter) in which the light source 911 and the first mirror 912 are integral; and the scanning unit U2 in which the second and third mirrors 913 and 914 are integrated; and the light source 911 which illuminates the document D is a long tubular light source formed of a xenon lamp or a fluorescent lamp; and the first to third mirrors are rectangular mirrors which are long in the main scanning direction; and the light source 911 and each of the first to third mirrors are arranged to be parallel.

There are two methods for reading the document image herein, one uses a stationary optical reading operation, and the other uses a moving optical reading operation. In the stationary optical reading operation, the following is the method for reading the images on the document D that is conveyed in the document reading region R. One sheet of the document D separated by the sending roller pair 901 is positioned by the registration roller pair 902 and is nipped by the rotating large diameter conveyance drum 903 and the following rollers 904 and 905 and guided by the guide 906. The sheet is conveyed along the outer periphery surface of the conveyance drum 903 to arrive at the document reading region R which is the space in which the slit glass 101 which is long in the main scanning direction and the conveyance drum 903 oppose each other.

The light source 911 illuminates the document D that has been conveyed to the document reading region R, and the reflected light L from the document image that was reflected at the document D via the slit glass 101 passes the first second and third mirrors 912, 913 and 914 and the focusing lens 915 and is focused and then entered into the image capturing element 916.

The document image information is then read by the image capturing element 916.

The document D that has passed the document reading region R is conveyed and discharged onto the discharge plate 907 in the case of one-side reading, and the paper is discharged on the paper discharge plate 907 by the paper discharge rollers 908.

In the moving optical reading operation, the following is the method for reading the images on the document D that is placed on the platen glass 102. The document D is placed on a platen glass 102 that has outer dimension which are larger than the outer dimension of the largest size document and the light source 911 and first mirror 912 form the movable scanning unit U1, while the second and third mirrors 913 and 914 form the scanning unit U2 and each moves in the sub scanning direction (conveyance direction of the document and horizontal direction in the drawing) as shown by the broken line, and while moving, the light source 911 illuminates the document D that is placed on the platen glass 102, and the reflected light L from the document image that was reflected at the document D via the platen glass 102 passes through the scanning unit U1, the scanning unit U2 and the focusing lens 915 and is thereby focused, and then entered into the image capturing element 916.

The document image information is then read by the image capturing element 916 in the same manner as the stationary optical reading operation.

Because the slit glass 101 and the platen glass 102 are positioned at the uppermost portion of the reading apparatus 91, and the transfer sheet P is conveyed on the top thereof, they are required to have enough strength or thickness so that they do not break during normal operation, and it is not only easy to increase the amount of the reflected light of the light from light source or the reflection light from the document but it is easy for paper powder and stains caused by tack labels and finger marks to adhere thereto.

For this reason, it is preferable to use the reading glass related to the present invention, which is described referring to FIGS. 1-4, the reading glass which has the antireflection function for reducing the attenuation of light due to increase in the reflected light on the reading glass, more preferably the antistatic function for reducing suctioning of the transfer sheet to the reading glass surface due to static electricity, and anti pollution function for reducing attachment of glue and the like.

The image capturing element 916 is formed of a line CCD and the light (document image) that is reflected at the document D and led via the mirror or the focusing lens is subjected to photoelectrical conversion for each pixel. The photoelectrically converted document image information is input into control section (not shown), and then subjected to image processing that is normally performed after analog/digital conversion, and then output as digital information to the scanning exposure section 93.

The image forming section 94 comprises a photoreceptor drum 92, a charging electrode 941; a scanning exposure section 93, a developing unit 942, a transfer electrode 943 and a separation electrode 944.

The photoreceptor drum 92 rotates in the direction of the arrow and uniform potential is applied by the charging electrode 941 and then the scanning exposure section 93 scans the surface of the rotating photoreceptor drum 92 based on the digital information, and thereby forms an electrostatic latent image corresponding to the image on document D.

The electrostatic latent image formed on the photoreceptor drum is then developed by the developing unit 942, and becomes a visible image as a toner image on the surface of the photoreceptor drum 92.

Transfer sheets P are stacked in the paper feeding cassette 951 and one sheet at a time of the transfer sheet P is conveyed to the paper feeding path 95 at the paper feeding section 952 which includes a double feed prevention mechanism.

The paper feeding path 95 is arranged upstream of the image forming section 94 and thus it has registration rollers 953.

The registration roller 953 is driven synchronously with the rotation of the toner image on the photoreceptor drum 92 to send the transfer sheet P to the transfer region (upper portion of the transfer electrode 943).

The toner image formed on the photoreceptor drum 92 is transferred to the transfer sheet P that was sent into the transfer region, and then the transfer sheet P is separated from the photoreceptor drum 92 by the separation electrode 944 and the separation claw (not shown), and then conveyed to the fixing unit 96 by the conveyance unit 954.

The cleaning unit 945 then cleans the surface of the transfer drum 92 after transfer is done, and foreign particles and residual toner and the like are removed.

When the residual toner has been removed, the charging electrode 921 again charges the surface of the photoreceptor drum 92 for the next copying operation.

In the fixing unit 96, the transfer sheet P and the toner image are heated and subjected to pressure and the toner image is fixed, and in the case of one-sided copy, the transfer sheet is nipped by the discharge rollers 955 and sent to the discharge tray (not shown).

In addition, in the case of double-sided copy, the transfer sheet P on which the toner image has been fixed is conveyed to the reverse conveyance path 957 by the conveyance roller 956 and the recording sheet P whose direction of movement was reversed at the reverse conveyance path 957 is conveyed to the conveyance path 958 and then conveyed and introduced to the sheet feeding path 95 and toner images are transferred again and fixed.

It is to be noted that needless to say, in the case of the color reading apparatus, a correction section for flattening frequencies corresponding to the frequency distribution of the light source and reading glass is necessary, and general use correction section may be used in the reading apparatus.

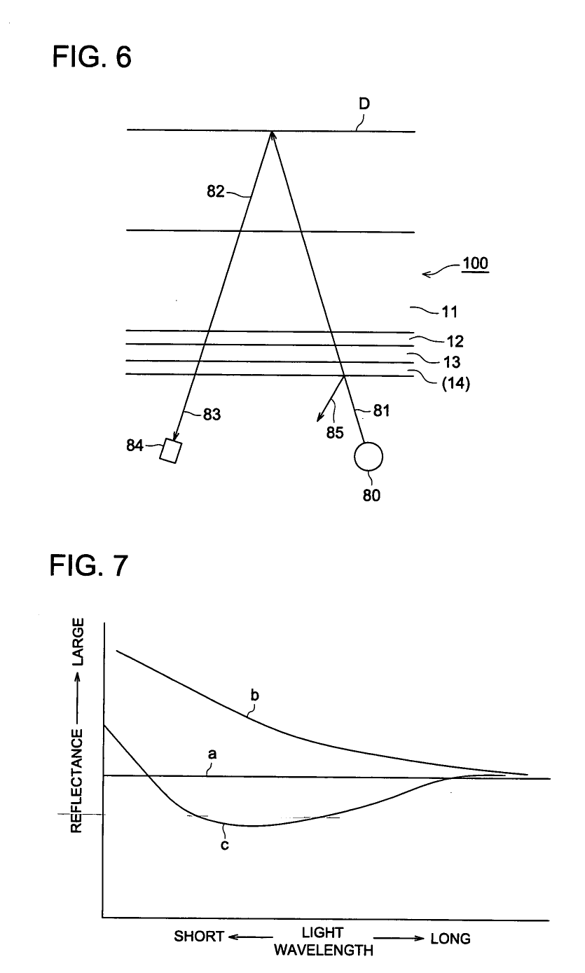

FIG. 6 is an explanatory view showing light from the light source hitting the document and the reflected light from the document being reflected.

The light 81 emitted from the light source 80 passes through the reading glass 100 (for example the equivalent of slit glass 101 or the platen glass 102) and illuminates the document D, and the reflected light 82 from the document D passes through the reading glass 100 again, and then the transmitted light 83 returns to the document reading section 84.

The reflectance of the reading glass hereinafter refers to the ratio of light amount between the light 81 emitted from the light source 80 and the light 85 reflected at the surface of the reading glass 100.

Reflectance=(amount of light 85 reflected at the surface of the reading glass 100/(amount of the light from light source 81 entering the reading glass 100))

FIG. 7 is an explanatory diagram for describing reduction of reflection at the reading glass due to the antistatic film and the antireflection film.

The vertical axis shows reflectance and the horizontal axis shows wavelength.

a shows the changes in reflectance for the wavelength of the glass surface of only the glass substrate. In this case it has no relationship with wavelength, and a flat value is shown.

b shows the changes in reflectance corresponding to the wavelength in the case where only an antistatic film with high refraction index is formed on the glass member, and reflectance is increased due to the antistatic film. As a result, transmitted light 83 shown in FIG. 6 reduces. In this case, a trend is shown in which the reflectance increases for the shorter wavelength.

c shows the changes in reflectance corresponding to the wavelength in the case where an antireflection film with a lower refraction index than the antistatic film (low refraction index film) is formed on the surface of the antistatic film and the reflectance is reduced compared to the reflectance of only the antireflection film due to the combination of the antistatic film and the low refraction index film. As a result, transmitted light 83 shown in FIG. 6 increases. In this case, a trend is shown in which the reflectance increases for the shorter wavelength and longer wavelength, and a trend is shown in which in the middle region, the reflectance reduces compared to the reflectance of only the glass substrate, and thus there is a convex portion at the lower side.

As described above, it is clear that by layering the antistatic layer and a layer with a lower refraction index than the antistatic layer on the surface of the glass substrate, the reflectance is reduced compared to the case where there is only glass substrate.

As a result, the transmittance of the reading glass is improved, and loss of the light from the light source and the reflected light from the document can be reduced.

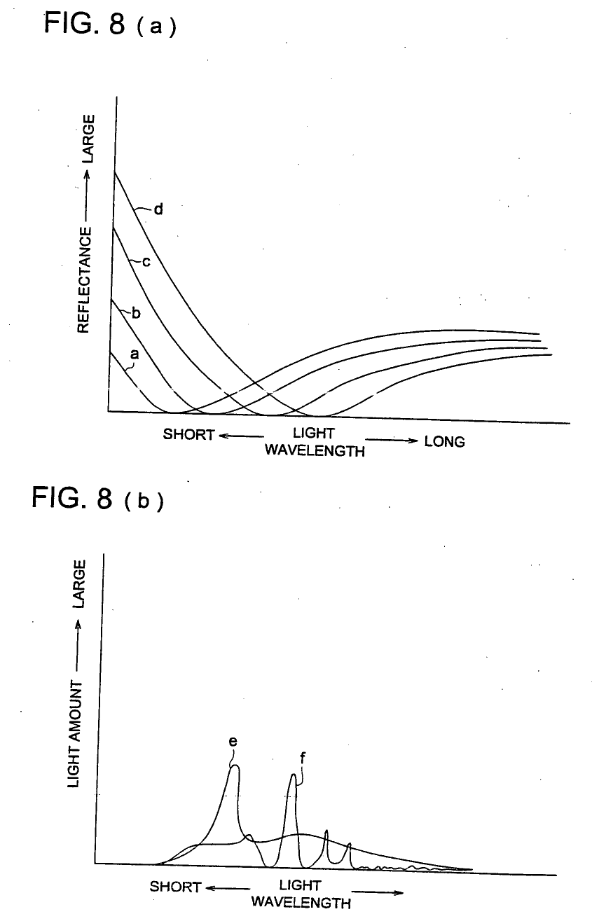

FIG. 8 is an explanatory diagram showing changes in reflection of the reading glass according to the thickness of the antireflection layer.

FIG. 8(a) shows the changes in reflectance with respect to light wavelength of the reading glass due to the thickness of the antireflection film when the antistatic film and the antireflection film are combined, and the vertical axis shows reflectance while the horizontal axis shows light wavelength.

FIG. 8(b) shows the frequency distribution of light from the light source, and the vertical axis shows emitted light amount while the horizontal axis shows light wavelength.

FIG. 8(a) shows the changes in the reflectance of the reading glass with respect to light frequency, and a is the case where the thickness of the antireflection film is approximately 75 nm; b is the case where the thickness of the antireflection film is approximately 85 nm, c is the case where the thickness of the antireflection film is approximately 100 nm, and d is the case where the thickness of the antireflection film is approximately 125 nm.

As shown in the figure, there is a reflection trend in which there is a convex shape at the lower side, the frequency at that lower convex portion (minimum reflectance portion) changes in accordance with the thickness of the antireflection film.

In addition, in FIG. 8(b), e shows the emitted light amount for light wavelength in the case where LED is used as the light source, and f shows the emitted light amount for light wavelength in the case where a fluorescent lamp is used as the light source.

The figure shows that the light wavelength at which each light source has a peak emission of light is different.

As shown in FIG. 8 (a) and (b), by selecting such an antireflection film thickness that the light wavelength that shows the peak emission of light source is identical to the light wavelength that shows minimum reflectance of the reading glass, it is possible to realize a reading glass corresponding to the light source.

The difference between the wavelength at which the light source has a peak emission of light and the wavelength at which the reading glass has a minimum reflectance is preferably less than or equal to ±100 nm.

That is to say, the wavelength indicating the minimum reflectance of the reading glass is changed by the thickness of the antireflection layer, and the thickness of the antireflection layer (low refraction index layer) is set such that the reflectance of the reading glass is minimum at the wavelength at which the emission of the light source is maximum.

### EXAMPLES

The following is a description of the working examples of this invention, but this invention is not to be limited by the following examples.

### Examples

Digital copier 1145C manufactured by Konica Minolta was used to perform reading and printing by using and successively replacing the reading glasses prepared under the following conditions and image quality was evaluated based on the presence or absence of noise and streaking.

TABLE 1

| | Reflectance % | | Transmittance % | | | | |
|---|---|---|---|---|---|---|---|
| | Light | Light | Light | | Noise | | |
| | source | source | source | Light source | | Light | |
| | wave- | wave- | wave- | wave- | Light | source: | |
| | length: | length: | length: | length: | source: | fluorescent | |
| Material | 470 nm | 550 nm | 470 nm | 550 nm | LED | lamp | Streaking |
| **1 | 4.3 | 4.2 | 90.3C | 90.7C | C | C | D |
| **2 | 6.6 | 5.5 | 87.0C | 88.6C | D | D | B |
| Example 1 | 1.2 | 3.8 | 92.5A | 91.3B | A | — (C) | B |
| Example 2 | 2.7 | 0.8 | 91.1B | 92.9A | — (C) | A | B |
| Example 3 | 2.7 | 0.8 | 91.1B | 92.9A | — (C) | A | A |
| Example 4 | — | — | 92.6A | 96.1A | — | A | A |

**Comparative Example

[Slit Glass Sample for Evaluation]

### Comparative Example 1

Chemically reinforced glass of a thickness of 3 mm manufactured by Nippon Sheet Glass was used as the glass substrate

### Comparative Example 2

15 nm of ITO was put on a glass substrate using vapor deposition and then fluorine processing was carried out. The fluorine processing was done by diluting Optool DSX manufactured by Daikin in 0.1% Sol-1 also manufactured by the same company and coating was performed using the dip coating method.

The film thickness was measured using a thin film XRD and the results was 3.6 nm and when the element composition on the surface on the film surface was measured by XPS in the vicinity of a 30° angle of incidence, the fluorine element surface was found to be 21%.

### Example 1

A 30 nm SnO₂ film was placed only on the back surface using the atmospheric pressure plasma method and then 85 nm of SiO₂ was layered thereon (light wavelength showing minimum reflectance: 420 nm).

It is to be noted that the surface of the glass member for loading the document is the front surface and the opposite surface is the back surface.

### Example 2

A 30 nm SnO₂ film was placed only on the back surface using the atmospheric pressure plasma method and then 125 nm of SiO₂ was layered thereon (light wavelength showing minimum reflectance: 540 nm)

### Example 3

Fluorine processing was performed on the front surface on the sample of Example 2. The fluorine processing was done by diluting Optool DSX manufactured by Daikin in 0.1% Sol-1 also manufactured by the same company and coating was performed using the dip coating method (light wavelength showing minimum reflectance: 540 nm).

The film thickness was measured using a thin film XRD and the result was 3.8 nm. The element composition on the surface on the film surface was measured by XPS in the vicinity of a 30° angle of incidence, the fluorine element surface was found to be 45%.

### Example 4

The same processing as in Example 3 was performed on both sides (light wavelength showing minimum reflectance: 540 nm).

Next, the method for preparing the glass samples of Examples 1-4 will be described.

[Film formation conditions for antistatic film SnO₂] Examples 1-4

a: P1

Film formation is carried out on a substrate under the conditions below using the atmospheric pressure plasma device shown in FIG. 3.

(Power Source Conditions)

Power source: (High frequency power source manufactured by Pearl Kogyo Co., Ltd) High frequency side 27 MHz 10 W/cm²

(Electrode Conditions)

The square electrodes which include the first electrode which is the moving base electrode, the second electrode and the fourth electrode are formed by performing ceramic spraying on the titanium pipe with a 30 mm square hollow and using this as the dielectric.

Dielectric thickness: 1 mm

Electrode width: 40 mm

Applied electrode temperature: 90° C.

Gap between substrate and electrodes: 1.5 mm

(Gas Conditions)

Ar gas for Tetrabutyl tin gasification: 1 slm

Discharge gas Ar: 10 slm

Auxiliary gas H₂: 0.2 slm

b: P2

Surface processing is carried out under the conditions below using the atmospheric pressure plasma device shown in FIG. 3.

(Power Source Conditions)

Power source: High frequency side 27 MHz 20 W/cm²

Dielectric thickness: 1 mm

Electrode width: 40 mm

Applied electrode temperature: 90° C.

Gap between substrate and electrodes: 1.5 mm

(Gas Conditions)

Discharge gas Ar: 10 L/min

Auxiliary gas O₂: 0.5 L/min

c: Moving base electrode

Temperature of moving electrode: 200° C.

d: P1 and P2 are continuously carried out while scanning back and forth. In particular, the fixed electrode 41 of P1 and the fixed electrode 51 of P2 are connected in series, and the high voltage side of the power source is connected thereto, while the low voltage side of the power source is connected to the moving base electrode 42, and the oxidation process of P2 can be done immediately after the thin film is formed in P1. The moving base electrode 42 moves at a speed of 200 mm/sec, and after performing back and forth processing 60 times, a 30 nm thin film (antistatic film) is formed.

[Film formation conditions for antistatic film SiO₂] Examples 1-4

Film formation is carried out on the antistatic film under the conditions below using the atmospheric pressure plasma device shown in FIG. 4.

(Power Source Conditions)

Power source to be superimposed

Low frequency side: (Haiden Laboratory impulse high frequency power source) ω1: 100 kHz, V1: 6 kV, I1: 8 mA/cm², output density: 16 W/cm²

High frequency side: (Pearl Kogyo impulse high frequency power source) ω2: 13.56 MHz, V2: 750V, I2: 150 mA, output density: 11 W/cm², IV1: 3.5 kV

(Electrode Conditions)

Square electrodes which are the moving base electrode which is the first electrode, the second electrode and the fourth electrode are formed by performing ceramic spraying on the titanium pipe with a 30 mm square hollow and using this as the dielectric.

Dielectric thickness: 1 mm

Electrode width: 40 mm

Applied electrode temperature: 90° C.

Gap between substrate and electrodes: 1.0 mm

(Gas Conditions)

N₂ gas for TEOS gasification: 0.2 slm

Discharge gas N₂: 20 slm

Auxiliary gas O₂: 1 slm

a: Moving base electrode

Temperature of moving electrode: 200° C.

b: Back and forth scanning is carried out continuously. In particular, the low frequency side power source is connected to the fixed electrode 61, while the high frequency side power source is connected to the moving base electrode 42. The moving base electrode 42 moves at a speed of 100 mm/sec, back and forth processing is performed 60 times, and a 85 nm thin film (Example 1 is formed, and back and forth processing is performed 90 times and a 125 nm (Examples 2-4) thin film (antireflection film) is formed.

[Evaluation Method]

The slit glasses shown in the comparative examples and the examples in Table 1 are evaluated by successively using them to perform reading and printing, and the presence or absence of unevenness and streaking was evaluated.

It is to be noted that the paper to be used for evaluation is commercially available A3 paper which has a ream weight of 55 kg and a line drawings with a low print ratio where the pixel ratio is 2%, 500 sheets were printed with a two sheet interval.

At the last 500th sheet solid white and halftone images were printed and the quality of the output images was evaluated.

[Evaluation Standards]

Evaluation of unevenness due to noise: The uniformity of halftone was visually determined and evaluated by being ranked as below.

A: Uniform image with no unevenness

B: A few thin spots of unevenness which are thin enough and harmless in practical use

C: A few thin linear spots of

D: A lot of sharp streak-like unevenness

Black streak evaluation: Evaluation was done based on the presence or absence and number of sharp black streaks which are on solid white images.

A: Uniform image with no streaks

B: A few black streaks which are harmless in practical use

C: A few sharp black streaks

D: A lot of sharp black streaks

Transmittance Evaluation Evaluated by the value of transmittance

A: 92% or more

B: 91% or more and less than 92%

C: less than or equal to 91%

The measuring devices used in the foregoing evaluation are as follows.

Transmittance: Spectrophotometer U-4000 manufactured by Hitachi is used in accordance with JIS-R-1635.

[Evaluation Results]

In Comparative Example 2, reflectance is increased because the antireflection film is on the plain glass substrate, and transmittance is reduced, and as a result noise increases. However, attachment of paper powder and the like is reduced, and streaking is reduced.

In Example 1, because an antireflection layer (85 nm) is formed on the antistatic film, reflectance of the light of wavelength 470 nm in particular is significantly reduced, and transmittance is increased, and thus, there is no noise for the LED light source in particular. In addition, streaking is reduced as a result of the antistatic film.

In Example 2, because an antireflection layer (125 nm) is formed, the reflectance of the light of wavelength 550 nm in particular is significantly reduced, and transmittance is increased, and thus, there is no noise for the fluorescent lamp light source in particular. In addition, streaking is reduced as a result of the antistatic film.

In Example 3, because a low friction film is also formed, attachment of paper powder and the like is further reduced without any changes in terms of noise and streaks, and there are no streaks.

In Example 4, because the low friction film is formed on both surfaces, the transmittance is increased.

Based on the results above, it was confirmed that by forming an antireflection film (with a lower reflection index than the antistatic film) on the antistatic film, the transmittance is significantly increased and by changing the thickness of the antireflection film, it was possible to change the wavelength (frequency) showing the maximum transmittance.

Also it was confirmed that in the case where LED is used for the reading light source, it is preferable that the antistatic film and the antireflection layer (85 nm) are formed, and in the case where a fluorescent lamp is used, it is preferable that the antistatic film and the antireflection layer (125 nm) are formed.

1-9. (canceled)

10. A glass member which is provided between a document and a light source of a reading apparatus for optically reading the document, the glass member comprising:
a glass substrate which has an antireflection function on at least one surface thereof.

11. The glass member of claim 10, wherein the glass substrate comprises an antireflection layer thereon which has the antireflection function.

12. The glass member of claim 11, wherein the antireflection layer comprises, in order from the surface of the glass substrate:
a first layer; and
a second layer which has a higher refraction index than the first layer.

13. The glass member of claim 10, wherein the substrate has antireflection functions on both surfaces thereof.

14. The glass member of claim 12, wherein a wavelength at which a reflectance of the glass member is minimum changes according to a thickness of the second layer, and the second layer has a thickness at which the reflectance of the glass member is minimum at a wavelength at which an emission of the light source is maximum

15. The glass member of claim 12, wherein the second layer includes a thin film containing silicon oxide, and the first layer includes a thin film containing one of ITO, tin oxide and zinc oxide.

16. The glass member of claim 12, wherein at least one of the first layer and the second layer is formed by atmosphere pressure plasma

17. A reading apparatus, comprising:
a glass member which is provided between a document and a light source of a reading apparatus for optically reading the document, the glass member including:
a glass substrate which has an antireflection function on at least one surface thereof.

18. An image forming apparatus, comprising:
a reading apparatus, including:
a glass member which is provided between a document and a light source of a reading apparatus for optically reading the document, the glass member having:
a glass substrate which has an antireflection function on at least one surface thereof.
